(19) United States
(12) Patent Application Publication
(10) Pub. No.: US 2007/0024904 A1
(43) Pub. Date: Feb. 1, 2007

(54) Imaging serial interface ROM

(76) Inventors: Richard L. Baer, Los Altos, CA (US); Vamsi K. Srikantam, Fremont, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/192,827

(22) Filed: Jul. 28, 2005

(51) Int. Cl. G06K 15/00

(52) U.S. Cl. 358/1.16

(57) ABSTRACT

Imaging serial interface ROM (ISIROM). An integrated circuit imaging device presents to external circuitry as a read-only memory (ROM) with a serial interface. The ISIROM contains internal memory which stores data from the imaging array. When active, the imaging array automatically fills an image buffer in the internal memory with image data. This image data may be accessed by external circuitry in random-access fashion. Control and status registers may be used to start and stop the imaging process, set and interrogate imaging parameters. The ISIROM may also include auxiliary processing circuitry to perform functions such as image compression, scaling, edge and feature extraction, and the like.

### BACKGROUND OF THE INVENTION

1. Field of the Invention

The present invention pertains to the art of image sensors, and more particularly, to interfacing high speed image sensors to digital logic.

2. Art Background

Image sensors, such as CCD or CMOS sensors have decreased in price and increased in quality and capability, making them desirous to include in small electronic devices and systems. As an example, the Micron MT9V112 sensor from Micron Technologies can capture 30 frames per second with VGA resolution.

However, such sensors are difficult to use in embedded systems. They output data and synchronization signals at high rates, and require many I/O connections. The MT9V112 requires at least 18 connections, including a 24-27 MHz clock signal and 8 high data rate digital outputs. The systems that use these devices must have enough computational power to decode the synchronization signals and to properly interpret the sequential data. As a consequence, high-speed image sensors are rarely used in low-power embedded systems.

High-speed image sensors produce data at such a high rate that it cannot be processed in real time. As a consequence, most high-speed image sensors are used in recording systems. The system is generally implemented with a high-speed camera and a PC. The high-speed camera provides a control interface (typically RS-232) that is used to adjust the capture conditions (e.g. exposure time), and a high-speed data interface. Commonly used high-speed interfaces include IEEE1394, CameraLink, and Gigabit Ethernet.

Disadvantages of high-speed image sensors, particularly to the designer of small or embedded systems include:

Data may only be accessed sequentially. The first row must be read out prior to the second row, and so on.

No buffering is provided. Embedded systems, in particular, have limited internal memory and may not be able to accept a complete image frame unless external memory is provided.

High-speed synchronization signals must be decoded in order to interpret the image data. Because of the high data rate, external synchronization logic is required.

The sensor “pushes” data at a fixed rate. Data must be read out of the sensor at a fixed rate or artifacts will appear in the image. Data must be “swallowed” at the rate at which it is produced. At high speed, external memory buffers are required.

A high speed clock must be provided, and must be synchronized to other elements of the system for data transfer.

Data and control signals travel on different paths.

High pin count; many I/O lines are required to control the image sensor and receive video data.

Power consumption is typically high, so the device is not suitable for use in low-power systems.

### SUMMARY OF THE INVENTION

An image sensor provides a serial read-only-memory (ROM) interface, common to microcontroller peripheral circuits. The Imaging Serial Interface ROM (ISIROM) contains an imaging pixel array interfaced with a buffer memory, and provides a standard serial interface such as I2C to control registers, image parameters, and the image buffer.

### BRIEF DESCRIPTION OF THE DRAWINGS

The present invention is described with respect to particular exemplary embodiments thereof and reference is made to the drawings in which:

FIG. 1 is a block diagram of an imaging serial interface ROM (ISIROM).

### DETAILED DESCRIPTION

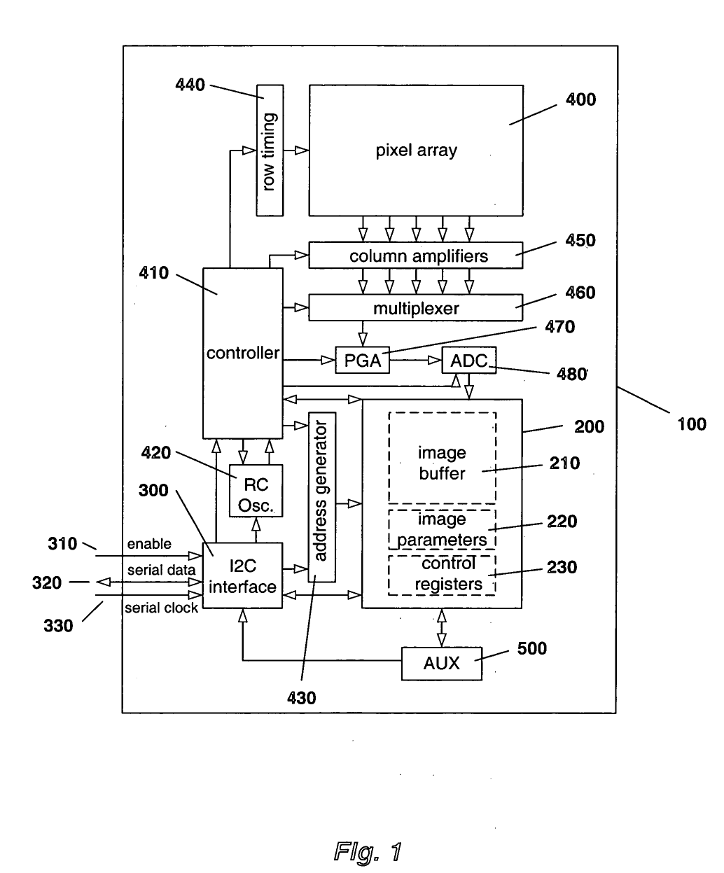

According to the present invention and as shown in FIG. 1, an imaging device is presented as a single integrated circuit (IC) serial interface read only memory device (ISIROM). ISIROM 100 interfaces memory 200 which contains image buffer 210, image parameters 220 and control registers 230 to a serial interface through interface controller 300. While the invention is described in terms of the well known I2C interface developed by Philips in the 1980s, other serial interfaces such as the three-wire serial interface popularized by Dallas Semiconductor, or SPI developed by Motorola may be used.

The I2C interface uses enable line 310, bidirectional serial data line 320, and serial clock line 330. I2C is a master/slave protocol, with the master initiating all communication. The ISIROM using the I2C protocol is a slave device. In an I2C transaction, the master device issues a start condition, informing all slave devices to listen on the serial data line. The master sends the address of the target slave device and a read/write flag. The slave device with the matching address responds with an acknowledgement signal on the serial data line. In an I2C embodiment of the ISIROM, it is anticipated that all ISIROM devices of the same type would share the same address. Some portion of the device address may be programmable, either through device pins or control registers. Once the target slave responds with the acknowledgement signal, communications proceeds between master and slave. The transmitting device sends data 8 bits at a time to the receiving device, and the receiving device replies with a 1-bit acknowledgement until the communication is complete. When the communication is complete, the master issues a stop condition.

Other serial interfaces may also be used, such as SPI developed by Motorola, or the serial interface common to serial memory chips and sensors such as the Dallas Semiconductor 1302 and 1620 sensors, or the Xicor and Atmel memory chips. This style of serial interface uses a single bidirectional data line but uses individual chip-select lines rather than device addresses.

Imaging pixel array 400 is driven by capture controller 410. Capture controller 410, based on clock signals from oscillator 420, generates control signals for row timing logic 440 which feeds pixel imaging array 400. The outputs of imaging array 400 are fed through column amplifiers 450 to multiplexer 460 and then to programmable gain amplifier (PGA) 470 and analog to digital converter (ADC) 480. The digital output of ADC 480 is stored in memory 200 at an address selected by address generator 430.

Image data stored in memory 200 may be accessed non-sequentially in random-access fashion over the serial interface. Image data may be captured, for example as a single frame, and the image data accessed. The entire image may be interrogated, or only selective areas of the image may be examined. Image data may also be accessed while image capture is ongoing. As an example, this allows for monitoring of certain image areas for change. Since the image data is buffered, interrogation of image data is controlled by the external device, and not by the imaging array.

Many different pixel array architectures could be used, such a CCD array, or a CMOS active-pixel (APS) architecture. CCD operation is discussed, for example, in Solid-State Imaging with Charged Coupled Devices by Theuwissen (pp. 109-128 Springer, 1995). APS architectures, such as the three transistor (3T) APS approach overcome some of the disadvantages of CCD sensors. The address event imaging architecture by Culurciello described in Proc. IEEE Intl. Symp. On Circuits and Systems 2001 (ISCAS 2001), Vol 3, pp. III-505 to III-508 could also be used. In this asynchronous architecture, a set of pixel coordinates is output whenever a pixel's voltage crosses a threshold. These coordinates could be used to increment a counter at that pixel location in buffer memory 200.

Control of the ISIROM imaging process is through memory-mapped control and status registers. A portion of RAM 200 is set aside for one or more image buffers 210, image parameter storage 220, and control registers 230. In the preferred embodiment, I2C read commands are used to read image data, along with capture, control, and image parameters. The I2C write command is used to program capture parameters and to initiate image capture. Control registers may be used to specify capture parameters such as image width, image height, and exposure duration. Image capture may be initiated by setting a bit in a capture register, and the status of image capture determined by reading a status register bit. Continuous and single-frame image capture may be supported. Image data is read-only, and is updated each time a new frame is captured.

CCD and CMOS image sensors typically consume from 20 to greater than 100 milliwatts of power when active. Imaging devices which produce video data streams require precise, stable clocks for operation at standard video rates, and to decrease the visibility of lighting artifacts such as flicker. Such systems typically use a crystal clock to provide the needed precision and stability. Crystal clocks start slowly, on the order of hundreds of milliseconds, so they cannot be quickly stopped and started. In contrast, since the present invention buffers image data into RAM 200, oscillator 420 does not have to be as precise or stable. In the preferred embodiment, a quick-starting oscillator such as an R-C oscillator is used for oscillator 420. The timing components for oscillator 420 may be entirely on-chip, or may be off-chip. By providing control of oscillator 420 through serial interface 300, the image acquisition process and oscillator 420 can be stopped and started, providing power savings. Since image data is stored in RAM 200, the image data is still available when the imaging circuitry is in a standby or low-power mode. Control and status registers 230 can optionally provide for low-resolution imaging with imaging array 400, reducing the number of pixel conversions required. High resolution image acquisition, and the associated higher power consumption, may be used only when needed.

Optionally, auxiliary processing logic 500 may be provided on-chip. Such auxiliary processing logic could include functions such as scaling of image size, scaling of image intensity, edge detection, feature extraction, image compression, motion detection, motion estimation, automatic exposure, automatic white balance, and/or dynamic range extension by combining images with different exposure durations into a single image. This auxiliary processing logic may be in the nature of fixed logic, a gate array such as an FPGA, or a microprocessor. In microprocessor implementations, memory containing the program sequences necessary for auxiliary processing may be stored in read only memory (ROM), electrically alterable memory such as EPROM, EEPROM, or Flash. Program sequences could also be provided through RAM 200.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. An imaging serial-interface ROM integrated circuit comprising:
an imaging pixel array,
an addressable buffer memory,
an image capture controller for capturing image data from the pixel array and storing the image data in the buffer memory, and
a serial interface controller providing a serial interface for communicating with logic external to the integrated circuit, the serial interface controller controlling the image capture controller and transferring information to and from the buffer memory via the serial interface.

2. The imaging serial interface ROM of claim 1 where the timing of the image capture controller is established by an R-C clock.

3. The imaging serial interface ROM of claim 2 where the timing components for the R-C clock are on the integrated circuit.

4. The imaging serial-interface ROM of claim 1 where the address space of the memory buffer is divided into at least one image buffer, and memory-mapped control and parameter registers.

5. The imaging serial interface ROM of claim 4 where the control and parameter registers provide for control of the imaging process.

6. The imaging serial interface ROM of claim 5 where the control registers provide for starting and stopping image capture.

7. The imaging serial interface ROM of claim 6 where the buffer memory provides random access to previously stored image data while image capture is stopped.

8. The imaging serial interface ROM of claim 6 where the buffer memory provides random access to image data during image capture.

9. The imaging serial interface ROM of claim 5 where the control registers provide for single frame image capture.

10. The imaging serial interface ROM of claim 1 further comprising:
auxiliary processing logic for processing stored image data from the buffer memory.

11. The imaging serial interface ROM of claim 10 where the type of auxiliary processing to be performed is determined by data stored in the buffer memory.
